(19) United States
(12) Patent Application Publication
(10) Pub. No.: US 2026/0261997 A1
(43) Pub. Date: Sep. 3, 2026

(54) Method for mmW Inter-Frequency Measurement Synchronization, A Computer Program Product, A Control Unit, and A Wireless Device Therefor

(71) Applicant: BEAMMWAVE AB, Lund (SE)

(72) Inventors: Joakim Axmon, Limhamn (SE); Bengt Lindoff, Bjärred (SE)

(21) Appl. No.: 18/846,700

(22) PCT Filed: Feb. 2, 2023
(86) PCT No.: PCT/SE2023/050087

§ 371 Date: Sep. 13, 2024

(30) Foreign Application Priority Data
Mar. 15, 2022 (SE) 2230074-3

(51) Int. Cl. H04W 56/00; H04L 5/00; H04W 76/15

(52) U.S. Cl. CPC H04W 56/0025; H04L 5/0048; H04L 5/0053; H04W 76/15

(57) ABSTRACT

A method for a control unit, the control unit being comprisable in a wireless device, WD, and being connectable to a plurality of transceivers the method comprising: allocating a first set of transceivers for communication within a first area provided by a first transceiver node, TNode; configuring the first set of transceivers to time and/or frequency synchronize with the first TNode; allocating a second set of transceivers for communication within a second area provided by a second TNode; determining whether the second TNode is in a non-active state or an active state; configuring the second set of transceivers to time and/or frequency synchronize with the first TNode or with the second TNode based on whether the second TNode is in non-active state or active state. Corresponding computer program product, control unit, and wireless device are also disclosed.

### TECHNICAL FIELD

The present disclosure relates to a method for mmW Inter-Frequency Measurement Synchronization, a computer program product, a control unit, and a wireless device therefor.

More specifically, the disclosure relates to a method for mmW Inter-Frequency Measurement Synchronization, a computer program product, a control unit, and a wireless device as defined in the introductory parts of the independent claims.

### BACKGROUND ART

Digital beamforming (BF) management for a wireless device (WD) comprises at least antenna selection and digital BF. Antenna selection relates to updating of a set of active antennas (and transceivers associated with the active antennas) based on measurements on synchronization signals, such as synchronization signal blocks (SSBs) transmitted in SSB bursts at SSB occasions (and/or channel state information reference symbols, CSI-RS, during time periods without SSB reception) for 5G/NR and the active antenna/transceiver set is thereafter utilized for digital BF on various physical channels and/or CSI-RS during time periods without SSB reception. An example of digital BF can be found in U.S. Pat. No. 9,054,845 B2.

The WD supports mobility, measurements on neighbour transmission (TX) beams (e.g., Transmission Configuration Indicator, TCI, states) and intra/inter frequency neighbour cell/area and TX beams. Furthermore, the WD receives configured time pattern for SSB monitoring from a base station (BS), such as an eNB, or a gNB, and manages multiple/main active transceiver/antenna set, Mu/Ma-ATS/AAS and multiple virtual active transceiver/antenna set Mu-VAAS/VATS for a respective active area/TCI and a respective configured handover (HO) candidate.

Carrier aggregation/dual connectivity is also supported for millimeter Wave (mmW), giving the WD the possibility of receiving radio signals over more than 400 MHz in 5G-NR. A power/energy efficient solution for supporting wide bandwidth (BW) carrier aggregation for mmW in a distributed transceiver architecture (e.g., a WD having a set of transceivers distributed all around it) is to allocate a first subset of transceivers for communication with a first serving base station (with a first carrier, within a first cell/area), and allocate a second subset of transceivers for communication with a second serving base station (with a second carrier, within a second cell/area).

U.S. Pat. No. 9,949,183 B2 discloses allocation of a first subset of transceivers for communication with a first serving base station, and allocation of a second subset of transceivers for communication with a second serving base station.

However, the current 3GPP 5G New Radio (5G-NR) standard assumes analog BF architectures and a single receiver for contiguous Carrier aggregation (CA) reception, with the primary Cell (PCell) and the secondary Cell (SCell) synchronized. Due to the lean carrier concept in 5G-NR, the SCell should avoid transmission of unnecessary signals (for power efficiency reasons). Thus, the SCell may not transmit synchronization signals such as SSBs. This may be a problem in a distributed transceiver architecture since it is not possible to monitor for active antenna set(s) (Mu/Ma-ATS/AAS, Mu-VAAS/VATS) on the SCell prior to activation (but only after configuration) of the SCell. This may lead to increased synchronization time.

Therefore, there may be a need for a method and/or an apparatus with a decreased synchronization time (for distributed transceiver architecture). Furthermore, there may be a need for improved user performance and/or reduced power consumption.

### SUMMARY

An object of the present disclosure is to mitigate, alleviate or eliminate one or more of the above-identified deficiencies and disadvantages in the prior art and solve at least the above-mentioned problem.

According to a first aspect there is provided a method for a control unit, the control unit being comprisable in a wireless device (WD), and being connectable to a plurality of transceivers, the method comprising: allocating a first set of transceivers for communication within a first area provided by a first transceiver node (TNode); configuring the first set of transceivers to time and/or frequency synchronize with the first TNode; allocating a second set of transceivers for communication within a second area provided by a second TNode; determining whether the second TNode is in a non-active state or an active state; and configuring the second set of transceivers to time and/or frequency synchronize with the first TNode or with the second TNode based on whether the second TNode is in non-active state or active state.

According to some embodiments, configuring the second set of transceivers to time and/or frequency synchronize with the first TNode or with the second TNode comprises: if the second TNode is in a non-active state, configuring the second set of transceivers to time and/or frequency synchronize with the first TNode; and if the second TNode is in an active state, configuring the second set of transceivers to time and/or frequency synchronize with the second TNode.

According to some embodiments, the first TNode and the second TNode utilize the same carrier frequency.

According to some embodiments, the first TNode and the second TNode utilize different carrier frequencies.

According to some embodiments, determining whether the second TNode is in a non-active state or an active state comprises: determining that the second TNode is in non-active state if the second TNode is in a deactivated state; and/or determining that the second TNode is in active state if the second TNode is in an activated state.

According to some embodiments, determining whether the second TNode is in a non-active state or an active state comprises: determining that the second TNode is in non-active state if the control unit has not been configured with information about physical resources available for time/frequency synchronization for the second TNode; and/or determining that the second TNode is in active state if the control unit has been configured with information about physical resources available for time/frequency synchronization for the second TNode. According to some embodiments, configuring the first set of transceivers to time and/or frequency synchronize with the first TNode comprises configuring the first set of transceivers to time and/or frequency synchronize with the first TNode utilizing physical resources, such as synchronization signal blocks, SSBs, channel state information reference signals, CSI-RS, or demodulation reference signals, DM-RS, received from the first TNode.

According to some embodiments, configuring 150 the second set of transceivers to time and/or frequency synchronize with the first TNode or with the second TNode comprises configuring the second set of transceivers to time and/or frequency synchronize with the first TNode utilizing physical resources, such as synchronization signal blocks, SSBs, channel state information reference signals, CSI-RS, or demodulation reference signals, DM-RS, received from the first TNode or configuring the second set of transceivers to time and/or frequency synchronize with the second TNode utilizing physical resources, such as synchronization signal blocks, SSBs, channel state information reference signals, CSI-RS, or demodulation reference signals, DM-RS, received from the second TNode.

According to a second aspect there is provided a computer program product comprising a non-transitory computer readable medium, having stored thereon a computer program comprising program instructions, the computer program being loadable into a data processing unit, comprisable in a control unit, and configured to cause execution of the method of the first aspect or any of the above-mentioned embodiments when the computer program is run by the data processing unit.

According to a third aspect there is provided a control unit, the control unit being comprisable in a wireless device (WD) and being connectable to a plurality of transceivers, the control unit being configured to: allocate a first set of transceivers for communication within a first area provided by a first transceiver node (TNode); configure the first set of transceivers to time and/or frequency synchronize with the first TNode; allocate a second set of transceivers for communication within a second area provided by a second TNode; determine whether the second TNode is in a non-active state or an active state; configure the second set of transceivers to time and/or frequency synchronize with the first TNode or with the second TNode based on whether the second TNode is in non-active state or active state.

According to a fourth aspect there is provided a wireless device (WD) comprising the control/processing unit of the third aspect and the plurality of transceivers.

Effects and features of the second, third and fourth aspects are fully or to a large extent analogous to those described above in connection with the first aspect and vice versa. Embodiments mentioned in relation to the first aspect are fully or largely compatible with the second, third, and fourth aspects and vice versa.

An advantage of some embodiments is that power consumption is reduced or optimized (e.g., for the wireless device).

Another advantage of some embodiments is that synchronization (with SCell) can be achieved fast/faster (especially for WDs with distributed transceiver architecture).

Yet another advantage of some embodiments is that blind search for synchronization signals on SCell is not necessary, thus significantly reducing power consumption.

Yet a further advantage of some embodiments is that energy efficiency is increased or improved.

A further advantage of some embodiments is that an improved user performance is achieved.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1 is a schematic drawing illustrating method steps according to some embodiments;

FIG. 2 is a schematic drawing illustrating a computer readable medium according to some embodiments;

FIG. 3 is a flowchart illustrating method steps implemented in a control unit according to some embodiments;

FIG. 4 is a schematic drawing illustrating a control unit which may be comprised in a wireless device according to some embodiments;

FIG. 5A is a schematic timing diagram illustrating communication between a wireless device and first and second transceiver nodes according to some embodiments;

FIG. 5B is a schematic drawing illustrating two transceiver nodes, and a wireless device, comprising transceivers, according to some embodiments;

FIG. 5C is a schematic timing diagram illustrating communication between a wireless device and a first transceiver node according to some embodiments, and

FIG. 5D is a schematic drawing illustrating two transceiver nodes, and a wireless device, comprising transceivers, according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to an “area”. An area below is to be interpreted as a cell of a cellular network or the geographical region that is covered by a transmission facility, e.g., a transceiver node, such as a base station. A transmission facility may comprise one or more cells or cover one or more geographical regions.

Below is referred to millimeter Wave (mmW) operation, mmW communication, mmW communication capability and mmW frequency range. The mmW frequency range is from 24.25 Gigahertz (GHz) to 71 GHz or more generally from 24 to 300 GHz. MmW may also be referred to as Frequency Range 2 (FR2).

Below is referred to a control unit. The control unit may be a controller, a processor, such as a digital processor or a processing unit. Alternatively, the control unit may be a microprocessor, a microcontroller, a central processing unit, a co-processor, a graphics processing unit, a digital signal processor, an image signal processor, a quantum processing unit, or an analog signal processor. As another alternative, the control unit is comprised in a microprocessor, a microcontroller, a central processing unit, a co-processor, a graphics processing unit, a digital signal processor, an image signal processor, a quantum processing unit, an analog signal processor or a baseband processor. The control unit may comprise one or more processors and optionally other units, such as one or more subunit(s).

Below is referred to a wireless device (WD). A wireless device is any device capable of transmitting or receiving signals wirelessly. Some examples of wireless devices are user equipment (UE), mobile phones, cell phones, smart phones, Internet of Things (IoT) devices, vehicle-to-everything (V2X) devices, vehicle-to-infrastructure (V2I) devices, vehicle-to-network (V2N) devices, vehicle-to-vehicle (V2V) devices, vehicle-to-pedestrian (V2P) devices, vehicle-to-device (V2D) devices, vehicle-to-grid (V2G) devices, fixed wireless access (FWA) points, and tablets.

Below is referred to a “transceiver node” (TNode). A TNode may be a remote radio unit (RRU), a repeater, a remote wireless node, or a base station (BS), such as a radio base station (RBS), a Node B, an Evolved Node B (eNB) or a gNodeB (gNB). Furthermore, a TNode may be a BS for a neighbouring cell, a BS for a handover (HO) candidate cell, a remote radio unit (RRU), a distributed unit (DU), another WD or a base station (BS) for a (active/deactivated) secondary cell (SCell) or for a serving/primary cell (PCell, e.g., associated with an active TCI state).

Below is referred to a “non-active state” (for a TNode). A “non-active” state (for a TNode) is to be interpreted as a state in which the WD has no information about physical resources available for time/frequency synchronization. Thus, an active state (for a TNode) is to be interpreted as a state in which the WD has information about physical resources available for time/frequency synchronization.

Below is referred to an antenna unit. An antenna unit may be one single antenna. However, an antenna unit may also be a dual antenna, such as a dual patch antenna with a first (e.g., horizontal) and a second (e.g., vertical) polarization, thus functioning as two separate antennas or an antenna unit having two ports.

Below is referred to a chip. A chip is an integrated circuit (chip) or a monolithic integrated circuit (chip) and may also be referred to as an IC, or a microchip.

Below is referred to an active transceiver. An active transceiver is a transceiver, which is utilized or ready to be utilized for transmission and/or reception, e.g., configured for transmission and/or reception or e.g., not in a (deep) sleep mode.

Herein is referred to a Transmission Configuration Indicator (TCI) State. A TCI state contains parameters for configuring a quasi-co-location relationship between one or two downlink reference signals and the Demodulation reference signal (DM-RS) ports of the physical downlink shared channel (PDSCH), the DM-RS port of physical downlink control channel (PDCCH) or the channel state information reference signal (CSI-RS) port(s) of a CSI-RS resource.

Herein is referred to an active TCI state. An active TCI state is the TCI state of a presently active transmit beam of a network node. In some standards, such as 3GPP standards, an active TCI state may be expressed as “indicated” (among potentially more than one “active” TCI state).

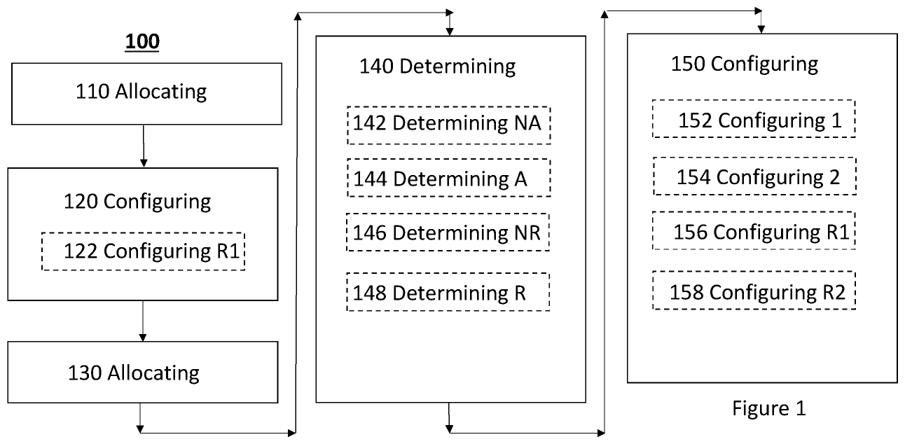

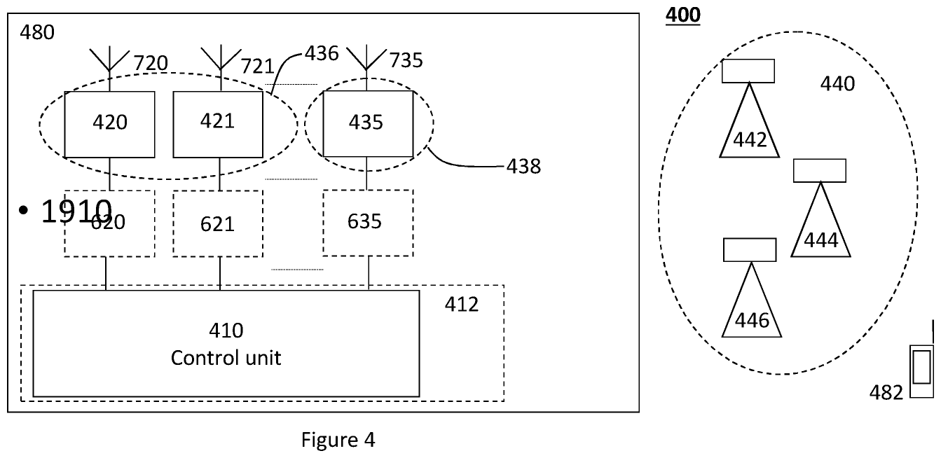

In the following, embodiments will be described where FIG. 1 illustrates method steps according to some embodiments. The method 100 is for a control unit 410 (shown in FIG. 4). The control unit 410 is comprisable or comprised in a wireless device, WD, 480 (shown in FIG. 4). Furthermore, the control unit 410 is associated with (connected or connectable to) a plurality of transceivers 420, 421, . . . , 435 (shown in FIG. 4). Moreover, the control unit 410 is able to control the plurality of transceivers 420, 421, . . . , 435. In some embodiments, the control unit 410 is configured to control the plurality of transceivers 420, 421, . . . , 435, e.g., for millimeter wave (mmW) multiple-input multiple-output (MIMO) and/or beamforming towards a set 440 of (remote) TNodes 442, 444, 446 (shown in FIG. 4) and/or towards one or more second WDs 482 (shown in FIG. 4), and/or to function in a multi-serving area mode, such as carrier aggregation or dual connectivity. In some embodiments the control unit 410 is comprised in a processing unit, such as a baseband processor. Moreover, in some embodiments, the control unit 410 is connected or connectable to the plurality of transceivers 420, 421, . . . , 435 either via analog to digital converters (ADCs) 620, . . . , 635 (shown in FIG. 4) or directly. Furthermore, in some embodiments, the transceivers 420, 421, . . . , 435 are connected or connectable to antenna units 720, . . . , 735 (shown in FIG. 4). The method comprises allocating 110 a first set 436 (shown in FIG. 4) of transceivers for communication within a first area provided by a first transceiver node, TNode, 442. The first TNode 442 may be a first serving BS. Furthermore, the method comprises configuring 120 the first set 436 of transceivers to time and/or frequency synchronize with the first TNode 442. Moreover, the method comprises allocating 130 a second set 438 (shown in FIG. 4) of transceivers for communication within a second area provided by a second TNode 444. The second TNode 444 may be a second serving BS. In some embodiments, the first and second TNodes 442, 444 are the same TNode. Alternatively, the first and second TNodes 442, 444 are different TNodes. The method comprises determining 140 whether the second TNode 444 is in a non-active state or an active state. In some embodiments, the determining 140 is performed by obtaining information from the second TNode 444. Moreover, in some embodiments, determining 140 whether the second TNode 444 is in a non-active state or an active state comprises determining 142 that the second TNode 444 is in non-active state if/when the second TNode 444 (or the second area provided by a second TNode 444) is in a deactivated state (has not been activated/has been deactivated/is inactive), i.e., in some embodiments, determining 140 whether the second TNode 444 is in a non-active state or an active state comprises, in response to the second TNode 444 being in a deactivated state, determining 142 that the second TNode 444 is in non-active state. Additionally, or alternatively, determining 140 whether the second TNode 444 is in a non-active state or an active state comprises determining 144 that the second TNode 444 is in active state if/when the second TNode 444 (or the second area provided by a second TNode 444) is in an activated state (has been activated/is active), i.e., determining 140 whether the second TNode 444 is in a non-active state or an active state comprises, in response to the second TNode 444 being in an activated state, determining 144 that the second TNode 444 is in active state.

In some embodiments, determining 140 whether the second TNode 444 is in a non-active state or an active state comprises determining 146 that the second TNode 444 is in non-active state if/when the control unit 410 has not (yet) been configured with information about physical resources available for time/frequency synchronization for the second TNode 444, e.g., since the latest connection setup or within a specified time period prior to the determining 140, such as within minute(s), an hour or ever before the determining 140 (i.e., determining 140, 146 may be event-triggered). I.e., in some embodiments, determining 140 whether the second TNode 444 is in a non-active state or an active state comprises, in response to the control unit 410 not (yet) being configured with information about physical resources available for time/frequency synchronization for the second TNode 444, determining 146 that the second TNode 444 is in non-active state. Additionally, or alternatively, determining 140 whether the second TNode 444 is in a non-active state or an active state comprises determining 148 that the second TNode 444 is in active state if/when the control unit 410 has been configured with information about physical resources available for time/frequency synchronization for the second TNode 444, such as since the latest connection setup or within minute(s), an hour or ever before the determining 140 (i.e., determining 140, 146 may be event-triggered). I.e., determining 140 whether the second TNode 444 is in a non-active state or an active state comprises, in response to the control unit 410 being configured with information about physical resources available for time/frequency synchronization for the second TNode 444, determining 148 that the second TNode 444 is in active state. As an example, if the control unit 410 (or the WD 480) has had the second cell/area configured as a serving cell/area, the control unit 410 has been configured with information about physical resources available for time/frequency synchronization for the second TNode 444. As another example, if the control unit 410 (or the WD 480) has not been configured with information about physical resources available for time/frequency synchronization for the second TNode 444 or configured with information from which it can deduce where in the (communication from the) second TNode 444, e.g., the SCell, to find resources for synchronization, it is determined that the second TNode 444 is in non-active state.

Furthermore, the method comprises configuring 150 the second set 438 of transceivers to time and/or frequency synchronize with the first TNode 442 or with the second TNode 444 based on (in dependence on, in accordance with) whether the second TNode 444 is in non-active state or active state. In some embodiments, configuring 150 the second set 438 of transceivers to time and/or frequency synchronize with the first TNode 442 or with the second TNode 444 comprises, if/when the second TNode 444 is in a non-active state, configuring 152 the second set 438 of transceivers to time and/or frequency synchronize with the first TNode 442, i.e., configuring 150 the second set 438 of transceivers to time and/or frequency synchronize with the first TNode 442 or with the second TNode 444 comprises, in response to the second TNode 444 being in a non-active state, configuring 152 the second set 438 of transceivers to time and/or frequency synchronize with the first TNode 442. Additionally, or alternatively, configuring 150 the second set 438 of transceivers to time and/or frequency synchronize with the first TNode 442 or with the second TNode 444 comprises, if/when the second TNode 444 is in an active state, configuring 154 the second set 438 of transceivers to time and/or frequency synchronize with the second TNode 444, i.e., configuring 150 the second set 438 of transceivers to time and/or frequency synchronize with the first TNode 442 or with the second TNode 444 comprises, in response to the second TNode 444 being in an active state, configuring 154 the second set 438 of transceivers to time and/or frequency synchronize with the second TNode 444. Furthermore, in some embodiments, the first TNode 442 and the second TNode 444 utilize the same carrier frequency. Alternatively, the first TNode 442 and the second TNode 444 utilize different carrier frequencies. The carrier frequency may be an Evolved Universal Terrestrial Radio Access Absolute Radio Frequency Channel Number (E-UTRA ARFCN), a UTRA Absolute Radio Frequency Channel Number (UARFCN), an Absolute Radio Frequency Channel Number (ARFCN), or a 5G (New Radio) Absolute Radio Frequency Channel Number (NR-ARFCN).

Moreover, in some embodiments, configuring 120 the first set 436 of transceivers to time and/or frequency synchronize with the first TNode 442 comprises configuring 122 the first set 436 of transceivers to time and/or frequency synchronize with the first TNode 442 utilizing physical resources received from the first TNode 442. Additionally, or alternatively, configuring 150 the second set 438 of transceivers to time and/or frequency synchronize with the first TNode 442 or with the second TNode 444 comprises configuring 156 the second set 438 of transceivers to time and/or frequency synchronize with the first TNode 442 utilizing physical resources received from the first TNode 442 (if the second TNode 444 is in a non-active state) or configuring 158 the second set 438 of transceivers to time and/or frequency synchronize with the second TNode 444 utilizing physical resources received from the second TNode 444 (if the second TNode 444 is in an active state). In some embodiments, the physical resources received from the first or the second TNode 444 are one or more of channel state information reference signals (CSI-RS), demodulation reference signals (DM-RS), and synchronization signal blocks (SSBs).

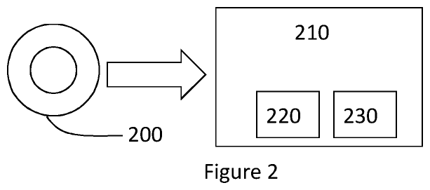

According to some embodiments, a computer program product comprising a non-transitory computer readable medium 200, such as a punch card, a compact disc (CD) ROM, a read only memory (ROM), a digital versatile disc (DVD), an embedded drive, a plug-in card, or a universal serial bus (USB) memory, is provided. FIG. 2 illustrates an example computer readable medium in the form of a compact disc (CD) ROM 200. The computer readable medium has stored thereon, a computer program comprising program instructions. The computer program is loadable into a data processor (PROC) 220, which may, for example, be comprised or comprisable in a computer 210 or a computing device or the control unit 410. When loaded into the data processor, the computer program may be stored in a memory (MEM) 230 associated with or comprised in the data processor. According to some embodiments, the computer program may, when loaded into and run by the data processor, cause execution of method steps according to, for example, the method illustrated in FIG. 1, which is described herein. Furthermore, in some embodiments, there is provided a computer program product comprising instructions, which, when executed on at least one processor of a processing device, cause the processing device to carry out the method illustrated in FIG. 1. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out the method illustrated in FIG. 1.

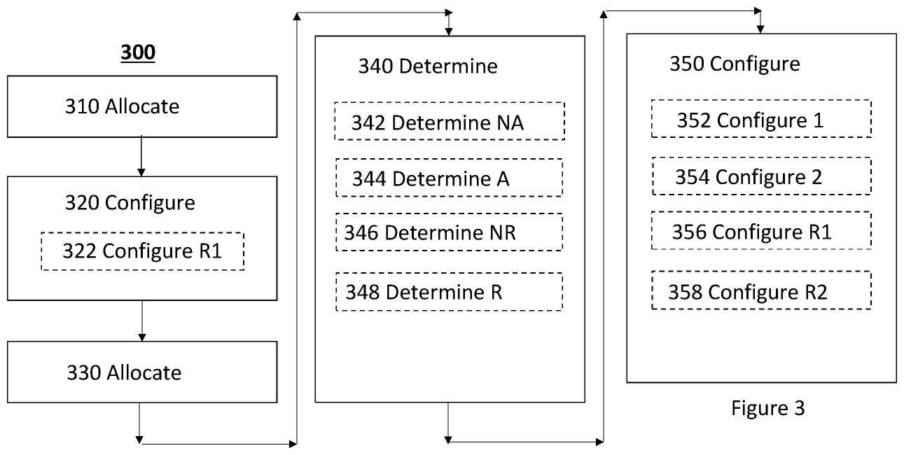

FIG. 3 illustrates method steps implemented in a control unit 410 (shown in FIG. 4 and described in connection therewith) according to some embodiments. The control unit 410 is associated with (e.g., operatively connectable, or connected, to) a plurality of transceivers 420, 421, . . . , 435 (shown in FIG. 4). Furthermore, the control unit 410 is able to control or controls the plurality of transceivers 420, 421, . . . , 435. Moreover, the control unit 410 is comprisable or comprised in a wireless device (WD) 480. The control unit 410 is configured to allocate 310 a first set 436 of transceivers for communication within a first cell/area provided by a first transceiver node (TNode) 442. To this end, the control unit 410 may be associated with (e.g., operatively connectable, or connected, to) one or first more first allocation units (e.g., first allocating circuitry or a first allocator). Furthermore, the control unit 410 is configured (or adapted) to configure 320 the first set 436 of transceivers to time and/or frequency synchronize with the first TNode 442. To this end, the control unit 410 may be associated with (e.g., operatively connectable, or connected, to) one or more first configuration units (e.g., first configuring circuitry or a first configurer). Moreover, the control unit 410 is configured to allocate 330 a second set 438 of transceivers for communication within a second cell/area provided by a second TNode 444. To this end, the control unit 410 may be associated with (e.g., operatively connectable, or connected, to) one or more second allocation units (e.g., second allocating circuitry or a second allocator). The control unit 410 is configured to determine 340 whether the second TNode 444 is in a non-active state or an active state. To this end, the control unit 410 may be associated with (e.g., operatively connectable, or connected, to) one or more first determination units (e.g., first determining circuitry or a first determiner). Furthermore, the control unit 410 is configured (or adapted) to configure 350 the second set 438 of transceivers to time and/or frequency synchronize with the first TNode 442 or with the second TNode 444 based on (in dependence on, in accordance with) whether the second TNode 444 is in non-active state or active state. To this end, the control unit 410 may be associated with (e.g., operatively connectable, or connected, to) one or more second configuration units (e.g., second configuring circuitry or a second configurer). In some embodiments, the control unit 410 is configured (or adapted) to configure 322 the first set 436 of transceivers to time and/or frequency synchronize with the first TNode 442 utilizing physical resources received from the first TNode 442. To this end, the control unit 410 may be associated with (e.g., operatively connectable, or connected, to) one or more third configuration units (e.g., third configuring circuitry or a third configurer). Moreover, in some embodiments, configure the control unit 410 to determine 340 whether the second TNode 444 is in a non-active state or an active state comprises configure the control unit 410 to determine 342 that the second TNode 444 is in non-active state if/when the second TNode 444 (or the second cell/area provided by a second TNode 444) is in a deactivated state. To this end, the control unit 410 may be associated with (e.g., operatively connectable, or connected, to) one or more second determination units (e.g., second determining circuitry or a second determiner). Additionally, or alternatively, configure the control unit 410 to determine 340 whether the second TNode 444 is in a non-active state or an active state comprises configure the control unit 410 to determine 344 that the second TNode 444 is in active state if/when the second TNode 444 (or the second cell/area provided by a second TNode 444) is in an activated state. To this end, the control unit 410 may be associated with (e.g., operatively connectable, or connected, to) one or more third determination units (e.g., third determining circuitry or a third determiner). Furthermore, in some embodiments, configure the control unit 410 to determine 340 whether the second TNode 444 is in a non-active state or an active state comprises configure the control unit 410 to determine 346 that the second TNode 444 is in non-active state if/when the control unit 410 has not (yet) been configured with information about physical resources available for time/frequency synchronization for the second TNode 444. To this end, the control unit 410 may be associated with (e.g., operatively connectable, or connected, to) one or more fourth determination units (e.g., fourth determining circuitry or a fourth determiner). Additionally, or alternatively, configure the control unit 410 to determine 340 whether the second TNode 444 is in a non-active state or an active state comprises configure the control unit 410 to determine 348 that the second TNode 444 is in active state if/when the control unit 410 has been configured with information about physical resources available for time/frequency synchronization for the second TNode 444, such as within the last hour or ever before. To this end, the control unit 410 may be associated with (e.g., operatively connectable, or connected, to) one or more fifth determination units (e.g., fifth determining circuitry or a fifth determiner). In some embodiments, configure (or adapt) the control unit 410 to configure 350 the second set 438 of transceivers to time and/or frequency synchronize with the first TNode 442 or with the second TNode 444 comprises, if/when the second TNode 444 is in a non-active state, configure (or adapt) the control unit 410 to configure 352 the second set 438 of transceivers to time and/or frequency synchronize with the first TNode 442. To this end, the control unit 410 may be associated with (e.g., operatively connectable, or connected, to) one or more fourth configuration units (e.g., fourth configuring circuitry or a fourth configurer). Additionally, or alternatively, configure (or adapt) the control unit 410 to configure 350 the second set 438 of transceivers to time and/or frequency synchronize with the first TNode 442 or with the second TNode 444 comprises, if/when the second TNode 444 is in an active state, configure (or adapt) the control unit 410 to configure 354 the second set 438 of transceivers to time and/or frequency synchronize with the second TNode 444. To this end, the control unit 410 may be associated with (e.g., operatively connectable, or connected, to) one or more fifth configuration units (e.g., fifth configuring circuitry or a fifth configurer).

Additionally, or alternatively, configure (or adapt) the control unit 410 to configure 350 the second set 438 of transceivers to time and/or frequency synchronize with the first TNode 442 or with the second TNode 444 comprises configure (or adapt) the control unit 410 to configure 356 the second set 438 of transceivers to time and/or frequency synchronize with the first TNode 442 utilizing physical resources received from the first TNode 442 or configure (or adapt) the control unit 410 to configure 358 the second set 438 of transceivers to time and/or frequency synchronize with the second TNode 444 utilizing physical resources received from the second TNode 444. To this end, the control unit 410 may be associated with (e.g., operatively connectable, or connected, to) one or more sixth configuration units (e.g., sixth configuring circuitry or a sixth configurer). In some embodiments, the one or more second configuration units comprise the fourth, the fifth and the sixth configuration units. Furthermore, in some embodiments, the one or more first determination units comprises the second, the third, the fourth and the fifth determination units.

FIG. 4 illustrates a control unit 410 according to some embodiments. The control unit 410 may be comprised in a wireless device (WD) 480. E.g., a WD 480 comprises the control unit 410 (e.g., the control unit 410 as described in connection with FIG. 3 above) and a plurality of transceivers 420, 421, . . . , 435. The control unit 410 is connected or connectable to the plurality of transceivers 420, 421, . . . , 435 directly or via analog to digital converters (ADCs) 620, 621, . . . , 635. Furthermore, in some embodiments, the transceivers 420, 421, . . . , 435 are connected or connectable to antenna units 720, 721, . . . , 735. The antenna units 720, 721, . . . , 735 are external or internal units. Furthermore, the antenna units 720, 721, . . . , 735 each have a vertical and/or a horizontal polarization. Moreover, the system 400 comprises the WD 480, one or more second WDs 482, and a set 440 of TNodes comprising a first TNode 442, a second TNode 444, and a third TNode 446. The plurality of transceivers 420, 421, . . . , 435 comprises a first set 436 of transceivers, a second set 438 of transceivers and a third set of transceivers (not shown). In some embodiments, the first set 436 comprises transceivers 420, 421 for communication within a first cell/area provided by the first Tnode 442, the second set 438 comprises transceivers 434, 435 for communication within a second cell/area provided by the second Tnode 444, and the third set comprises transceivers, e.g., 422, . . . , 433, which have not been allocated for communication with any of the first and second TNodes 442, 444.

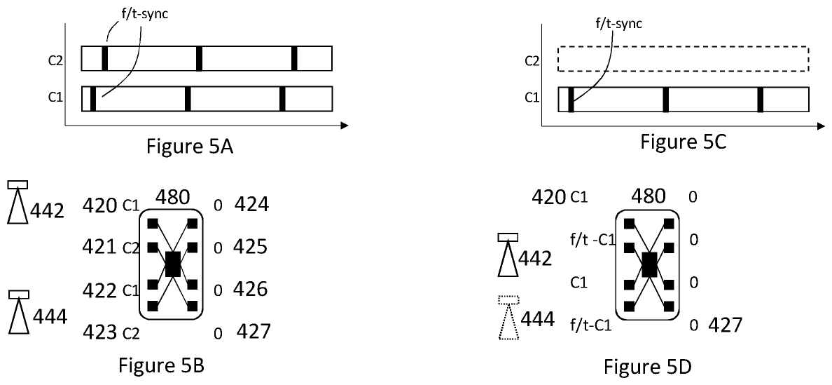

FIG. 5A illustrates a timing diagram for communication between a wireless device (WD) 480 and first and second TNodes 442, 444. The the WD 480 or the control unit 410 thereof may be configured to control the plurality of transceivers 420, 421, . . . , 435, e.g., for millimeter wave (mmW) multiple-input multiple-output (MIMO) and/or beamforming towards a set of (remote) TNodes, and/or to function in a multi-serving area mode, such as carrier aggregation or dual connectivity. Thus, different antenna units and/or transceivers may be allocated to different carriers/serving cells/areas. Furthermore, in some embodiments, e.g., for improved power efficiency, a first set 436 of transceivers is associated with a first reference clock and a second set of transceivers 438 is associated with a second reference clock, different from the first reference clock, i.e., the first set 436 of transceivers is controlled by a first Chrystal oscillator (XO) while the second set 438 of transceivers is controlled by a second XO, different from the first XO. Moreover, in some embodiments, a set of transceivers, such as the second set 438 of transceivers, is configured for a carrier (e.g., associated with an SCell) which is not currently active. However, since the WD 480 does not have any knowledge about resources for time and/or frequency synchronization available at the non-active carrier, time and/or frequency synchronization towards the carrier is not performed. Furthermore, once the carrier has been activated, the set of transceivers may need to perform time and/or frequency re-synchronization prior to establishing reliable reception. Hence, the set of transceivers will likely have poor quality of service at the start of the activation of the carrier.

FIG. 5B illustrates two transceiver nodes 442, 444, and a wireless device (WD) 480 comprising 8 transceivers 420, . . . , 427. The WD 480 is configured for carrier aggregation. The control unit 410 of the WD 480 has allocated two transceivers 420, 422 (with antennas units 720, 722; first set 436) for a first carrier C1, e.g., for communication within a first area provided by a first TNode 442. The first area may be a primary serving cell/area. Furthermore, the control unit 410 of the WD 480 has allocated two transceivers 421, 423 (with antennas units 721, 723; second set 438) for a second carrier C2, e.g., for communication within a second area provided by a second TNode 444. The second area may be a secondary serving cell/area. Moreover, 4 transceivers 424, . . . , 427 are not allocated to any carrier at all. This may be because the transceivers 424, . . . , 427 are not directed towards any of the first and second TNodes 442, 444. Once a carrier, e.g., first or second carrier C1, C2, has been configured to be active for the WD 480, the WD 480 knows which time occasions can be utilized for time and/or frequency synchronization, e.g., time occasions for SSB transmission for respective cell/area (SSB index). In the example depicted in FIGS. 5A-5B both the first and second carriers C1, C2, have been configured to be active for the WD 480. The time and/or frequency synchronization for the first and second sets 436, 438 allocated for the first and second carriers C1, C2 is performed on the respective carrier's C1, C2 time occasions at which time and/or frequency synchronization is possible, such as at time occasions of SSB reception.

FIG. 5C illustrates a timing diagram for communication between a WD 480 and a first TNode 442 and FIG. 5D illustrates two transceiver nodes, and a wireless device comprising 8 transceivers. The second TNode 444, which may be an SCell, has been deactivated, e.g., due to low volumes of data (and thus all data can be transmitted from the first TNode 442). In this case, the transceivers 421, 423 (with antennas units 721, 723; second set 438) allocated for the second carrier C2 may perform time and/or frequency synchronization towards the first carrier C1 at time occasions which can be utilized for time and/or frequency synchronization. Thus, the transceivers 421, 423 (second set 438) allocated for the second carrier C2 may keep the time and/or frequency synchronization towards the network even when the second TNode 444 is deactivated. When the second TNode 444 is re-activated (activated again) the transceivers 421, 423 (second set 438) are already in-sync and hence ready to transmit and/or receive data on the second carrier C2 right away. This may be advantageous as there is no need for blind search for possible synchronization signals transmitted on the second carrier C2, thus reducing power consumption.

In some embodiments/aspects, a chip 412 is provided (shown in FIG. 4). The chip 412 comprises the control unit 410. Alternatively, the chip comprises a baseband processor and the baseband processor comprises the control unit 410. In some embodiments, the chip 412 comprises one or more ADCs 620, 621, . . . , 635. Furthermore, in some embodiments, the chip 412 comprises one or more transceivers 420, 421, . . . , 435. Moreover, in some embodiments, the WD 480 comprises the chip 412.

### List of Examples:

1. A method (100) for a control unit (410), the control unit (410) being comprisable in a wireless device, WD, (480) and being connectable to a plurality of transceivers (420, . . . , 435), the method comprising:
   allocating (110) a first set (436) of transceivers for communication within a first cell/area provided by a first transceiver node, TNode, (442);
   configuring (120) the first set (436) of transceivers to time and/or frequency synchronize with the first TNode (442);
   allocating (130) a second set (438) of transceivers for communication within a second cell/area provided by a second TNode (444);
   determining (140) whether the second TNode (444) is in a non-active state or an active state; and
   configuring (150) the second set (438) of transceivers to time and/or frequency synchronize with the first TNode (442) or with the second TNode (444) based on whether the second TNode (444) is in non-active state or active state.
2. The method of example 1, wherein configuring (150) the second set (438) of transceivers to time and/or frequency synchronize with the first TNode (442) or with the second TNode (444) comprises:
   if the second TNode (444) is in a non-active state, configuring (152) the second set (438) of transceivers to time and/or frequency synchronize with the first TNode (442); and
   if the second TNode (444) is in an active state, configuring (154) the second set (438) of transceivers to time and/or frequency synchronize with the second TNode (444).
3. The method of any of examples 1-2, wherein the first TNode (442) and the second TNode (444) utilize the same carrier frequency.
4. The method of any of examples 1-2, wherein the first TNode (442) and the second TNode (444) utilize different carrier frequencies.
5. The method of any of examples 1-4, wherein determining (140) whether the second TNode (444) is in a non-active state or an active state comprises:
   determining (142) that the second TNode (444) is in non-active state if the second TNode (444) is in a deactivated state; and/or
   determining (144) that the second TNode (444) is in active state if the second TNode (444) is in an activated state.
6. The method of any of examples 1-4, wherein determining (140) whether the second TNode (444) is in a non-active state or an active state comprises:
   determining (146) that the second TNode (444) is in non-active state if the control unit (410) has not been configured with information about physical resources available for time/frequency synchronization for the second TNode (444); and/or
   determining (148) that the second TNode (444) is in active state if the control unit (410) has been configured with information about physical resources available for time/frequency synchronization for the second TNode (444).
7. The method of any of examples 1-6, wherein configuring (120) the first set (436) of transceivers to time and/or frequency synchronize with the first TNode (442) comprises configuring (122) the first set (436) of transceivers to time and/or frequency synchronize with the first TNode (442) utilizing physical resources, such as synchronization signal blocks, SSBs, channel state information reference signals, CSI-RS, or demodulation reference signals, DM-RS, received from the first TNode (442); and/or
   wherein configuring (150) the second set (438) of transceivers to time and/or frequency synchronize with the first TNode (442) or with the second TNode (444) comprises:
   configuring (156) the second set (438) of transceivers to time and/or frequency synchronize with the first TNode (442) utilizing physical resources, such as synchronization signal blocks, SSBs, channel state information reference signals, CSI-RS, or demodulation reference signals, DM-RS, received from the first TNode (442); or
   configuring (158) the second set (438) of transceivers to time and/or frequency synchronize with the second TNode (444) utilizing physical resources, such as synchronization signal blocks, SSBs, channel state information reference signals, CSI-RS, or demodulation reference signals, DM-RS, received from the second TNode (444).
8. A computer program product comprising a non-transitory computer readable medium (200), having stored thereon a computer program comprising program instructions, the computer program being loadable into a data processing unit (220) and configured to cause execution of the method of any of examples 1-7 when the computer program is run by the data processing unit.
9. A control unit (410), the control unit (410) being comprisable in a wireless device, WD, (480) and being connectable to a plurality of transceivers (420, . . . , 435), the control unit (410) being configured to:
   allocate (310) a first set (436) of transceivers for communication within a first cell/area provided by a first transceiver node, TNode (442);
   configure (320) the first set (436) of transceivers to time and/or frequency synchronize with the first TNode (442);
   allocate (330) a second set (438) of transceivers for communication within a second cell/area provided by a second TNode (444);
   determine (340) whether the second TNode (444) is in a non-active state or an active state;
   configure (350) the second set (438) of transceivers to time and/or frequency synchronize with the first TNode (442) or with the second TNode (444) based on whether the second TNode (444) is in non-active state or active state.
10. A wireless device, WD, (480) comprising the control unit (410) of example 9 and the plurality of transceivers (420, . . . , 435).

Generally, all terms used herein are to be interpreted according to their ordinary meaning in the relevant technical field, unless a different meaning is clearly given and/or is implied from the context in which it is used. Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step. In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer e.g., a single) unit. Any feature of any of the embodiments/aspects disclosed herein may be applied to any other embodiment/aspect, wherever suitable. Likewise, any advantage of any of the embodiments may apply to any other embodiments, and vice versa. Hence, it should be understood that the details of the described embodiments are merely examples brought forward for illustrative purposes, and that all variations that fall within the scope of the claims are intended to be embraced therein.

1. A method for a control unit, the control unit being comprisable in a wireless device (WD) and being connectable to a plurality of transceivers, the method comprising:
allocating a first set of transceivers for communication within a first cell/area provided by a first transceiver node (TNode);
configuring the first set of transceivers to time and/or frequency synchronize with the first TNode;
allocating a second set of transceivers for communication within a second cell/area provided by a second TNode;
determining whether the second TNode is in a non-active state or an active state; and
configuring the second set of transceivers to time and/or frequency synchronize with the first TNode or with the second TNode based on whether the second TNode is in non-active state or active state.

2. The method of claim 1, wherein configuring the second set of transceivers to time and/or frequency synchronize with the first TNode or with the second TNode comprises:
if the second TNode is in a non-active state, configuring the second set of transceivers to time and/or frequency synchronize with the first TNode; and
if the second TNode is in an active state, configuring the second set of transceivers to time and/or frequency synchronize with the second TNode.

3. The method of claim 1, wherein the first TNode and the second TNode utilize the same carrier frequency.

4. The method of claim 1, wherein the first TNode and the second TNode utilize different carrier frequencies.

5. The method of claim 1, wherein determining whether the second TNode is in a non-active state or an active state comprises:
determining that the second TNode is in non-active state if the second TNode is in a deactivated state.

6. The method of claim 1, wherein determining whether the second TNode is in a non-active state or an active state comprises:
determining that the second TNode is in active state if the second TNode is in an activated state.

7. The method of claim 1, wherein determining whether the second TNode is in a non-active state or an active state comprises:
determining that the second TNode is in non-active state if the control unit has not been configured with information about physical resources available for time/frequency synchronization for the second TNode.

8. The method of claim 1, wherein determining whether the second TNode is in a non-active state or an active state comprises:
determining that the second TNode is in active state if the control unit has been configured with information about physical resources available for time/frequency synchronization for the second TNode.

9. The method of claim 1 wherein configuring the first set of transceivers to time and/or frequency synchronize with the first TNode comprises configuring the first set of transceivers to time and/or frequency synchronize with the first TNode utilizing physical resources received from the first TNode.

10. The method of claim 9, wherein the physical resources comprise synchronization signal blocks (SSBs), channel state information reference signals (CSI-RS), or demodulation reference signals (DM-RS).

11. The method of claim 1, wherein configuring the second set of transceivers to time and/or frequency synchronize with the first TNode or with the second TNode comprises:
configuring the second set of transceivers to time and/or frequency synchronize with the first TNode utilizing physical resources received from the first TNode.

12. The method of claim 11, wherein the physical resources comprise synchronization signal blocks (SSBs), channel state information reference signals (CSI-RS), or demodulation reference signals (DM-RS).

13. The method of claim 1 wherein configuring the second set of transceivers to time and/or frequency synchronize with the first TNode or with the second TNode comprises:
configuring the second set of transceivers to time and/or frequency synchronize with the second TNode utilizing physical resources received from the second TNode.

14. The method of claim 13, wherein the physical resources comprise synchronization signal blocks (SSBs), channel state information reference signals (CSI-RS), or demodulation reference signals (DM-RS).

15. (canceled)

16. A non-transitory computer-readable storage medium storing one or more programs configured to be executed by one or more processors of a processing device, the one or more programs comprising instructions which, when executed by the processing device, causes the processing device to carry out the method according to claim 1.

17. A control unit, the control unit being comprisable in a wireless device (WD) and being connectable to a plurality of transceivers, the control unit being configured to:
allocate a first set of transceivers for communication within a first cell/area provided by a first transceiver node (TNode);
configure the first set of transceivers to time and/or frequency synchronize with the first TNode;
allocate a second set of transceivers for communication within a second cell/area provided by a second TNode;
determine whether the second TNode is in a non-active state or an active state; and
configure the second set of transceivers to time and/or frequency synchronize with the first TNode or with the second TNode based on whether the second TNode is in non-active state or active state.

18-19. (canceled)
